(19) United States
(12) Patent Application Publication
(10) Pub. No.: US 2008/0276289 A1
(43) Pub. Date: Nov. 6, 2008

(54) System for video presentations with adjustable display elements

(76) Inventor: Johannes Marinus Stephanus van Ottele, Rotterdam (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 12/154,267

(22) Filed: Nov. 14, 2007

Related U.S. Application Data
(63) Continuation-in-part of application No. PCT/NL2006/050286, filed on Nov. 14, 2006.

(51) Int. Cl. H04N 7/173

(52) U.S. Cl. 725/87

(57) ABSTRACT

A client computer, for viewing a media presentation, includes a processor and memory. The processor is connected to the memory. The client computer is arranged for connecting to a network and for receiving video image data from a video server on the network. The client computer is further arranged for making a content request to a content server on the network, for receiving content data from the content server, and for composing a composed video image based on the video image data and the content data. The content request includes content request data that are associated with the received video image data, and the content data are associated with the video image data.

### FIELD

The present invention relates to a system for video presentations with adjustable display elements. Also, the present invention relates to a method for producing video presentations with adjustable display elements. Moreover, the present invention relates to a computer program for video presentations with adjustable display elements.

### BACKGROUND

Video presentations or video clips are well known from television broadcasts. A television broadcast provides a transmission (i.e., a stream of video and audio information) to some television equipment, where a consumer can watch the presentation.

Due to the availability of personal computers and communication networks such as the Internet, there is a trend to watch broadcasts more and more on a personal computer or on media equipment such as smart phones, personal digital assistants.

Basically, for watching broadcasts/video clips, a user uses the personal computer to select a broadcast from a server located on a wide area network (i.e., the Internet).

After selection of a broadcast, the personal computer fetches the data stream of the selected broadcast from the server or from an associated server which is arranged to handle the data stream. Such a data stream is also known as a streaming video. By means of a media presentation program the processor carries out instruction so as to processes the streaming video in such a way that the selected broadcast is shown on a display connected to the personal computer.

Disadvantageously, the content of a streaming video, or a downloadable video data file, according to the prior art is invariable. Typically, the streaming video or video data file on the server relates to a copy of a television broadcast, video clip or simply a video recording or movie. The streaming video or video data file has been stored on the server and is transmitted as such to the personal computer that requests to receive the streaming video. As a result, the media presentation as displayed on the personal computer is simply the reproduction of the stored streaming video.

### SUMMARY

It is an object of the present invention to provide a system and a method which allow a media presentation with a streaming video of variable content.

In an aspect the present invention relates to a client computer, for viewing a media presentation, comprising a processor and memory, the processor being connected to the memory; the client computer being arranged for connecting to a network and for receiving video image data from a video server on the network; the client computer further being arranged for—making a content request to a content server on the network, for receiving content data from the content server, the content request comprising content request data being associated with the received video image data, and the content data being associated with the video image data, and—composing a composed video image based on the video image data and the content data.

Advantageously, the present invention achieves that the media presentation is no longer an invariable reproduction of a pre-recorded or captured video stream, but can be variable, adjustable, adaptable or even interactive, based on the received content data.

In an aspect, the present invention relates to a video server comprising a processor and memory, the processor being connected to the memory; the video server being arranged for connecting to a network and being arranged for providing a video stream to a client computer on the network; the video stream comprising a sequence of video frames; the video server being arranged for combining a video frame from said sequence of video frames with an identifier for said client computer into video data, the video data being transmitted to the client computer.

In an aspect, the present invention relates to a content server comprising a processor and memory, the processor being connected to the memory; the content server being arranged for connecting to a network and being arranged for providing content data to a client computer, the client computer being arranged for composing the content data with video data from a video server, wherein the content server is arranged for preparing the content data in relation to a content request received from the client computer.

In an aspect the present invention relates to a method for viewing a media presentation, comprising:

receiving video image data from a video server on a network;

making a content request to a content server on the network, for receiving content data from the content server, the content request comprising content request data being associated with the received video image data, and the content data being associated with the video image data, and

composing a composed video image based on the video image data and the content data.

In an aspect, the present invention relates to a computer program, for viewing a media presentation, to be loaded by a client computer, the client computer comprising a processing unit and memory; the processing unit being connected to the memory; the client computer being arranged for connecting to a network, the computer program after being loaded allowing the processing unit to carry out:

receiving video image data from a video server on the network;

making a content request to a content server on the network, for receiving content data from the content server, the content request comprising content request data being associated with the received video image data, and the content data being associated with the video image data, and

composing a composed video image based on the video image data and the content data.

### BRIEF DESCRIPTION OF DRAWINGS

Embodiments of the invention will now be described, by way of example only, with reference to the accompanying schematic drawings in which corresponding reference symbols indicate corresponding parts, and in which:

FIG. 1 shows a schematic diagram of a system according to the present invention;

FIG. 2 shows a schematic diagram of a client computer according to the present invention;

FIG. 3 shows a schematic diagram of a media presentation program according to an embodiment of the present invention;

FIG. 4 shows a schematic diagram of a media presentation program according to a further embodiment of the present invention;

FIG. 5 shows a flow diagram of a portion of the media presentation program;

FIG. 6 shows a flow diagram of a program to be carried out by a streaming video server in accordance with the present invention;

FIG. 7 shows a flow diagram of a program to be carried out by a content server in accordance with the present invention;

FIG. 8a, 8b, 8c, 8d, 8e show schematic examples of media presentation frames in accordance with the media presentation program of the present invention;

FIG. 9 shows a schematic diagram of a system according to an embodiment;

FIG. 10 shows a schematic diagram of a computation device.

### DETAILED DESCRIPTION

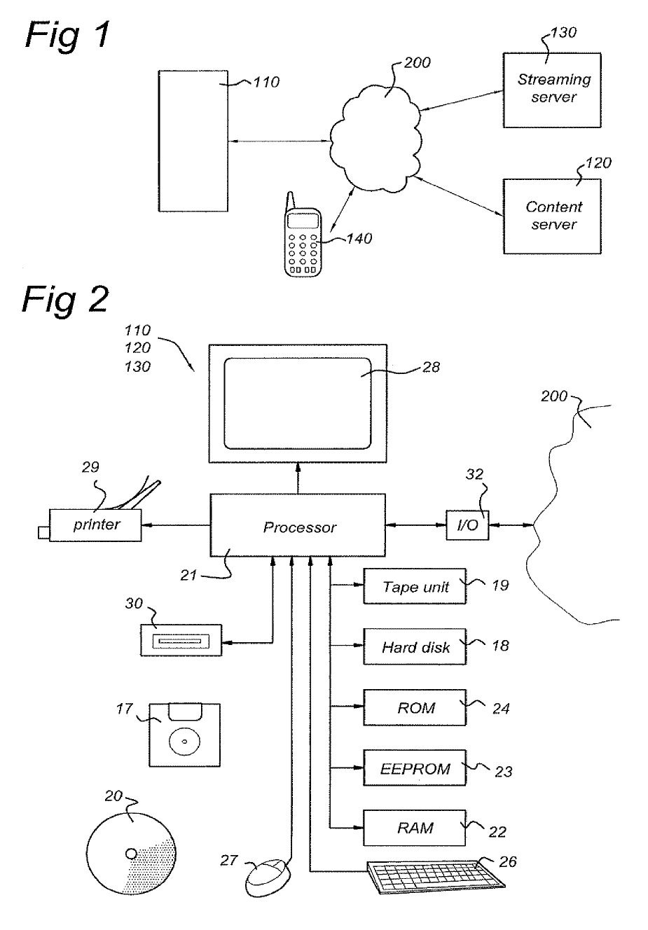

FIG. 1 shows a schematic diagram of a system according to the present invention. A system 100 according to the present invention comprises a client computer 110, a content server 120 and a streaming video server 130.

The client computer 110 is capable of connecting to the content server 120 and the streaming video server 130 over a data communication network 200.

The data-communication network 200 may be any network suitable for data transmission and may comprise a plurality of interconnected networks, for example, Public Switched Telephone Networks (PSTN). For instance such an interconnected network may be a Local Area Network (LAN), or a Wide Area Network (WAN). Also, the network 200 may have the functionality of the world-wide data-communication network, known as the Internet.

Moreover, the data communication network 200 may, in its entirety or in part, be either a wired network or a wireless network.

FIG. 1 also depicts an alternative client computer 140 which may be embodied as a smart phone. The client computer may also be embodied as a personal digital assistant device, a portable media player, a set-top box or a digital television set (such as a HDTV set).

According to one embodiment of the present invention, the client computer 110 is arranged to receive streaming video from the streaming video server 130 and content data from the content server 120 in which the received content data is associated with the received streaming video.

Streaming video relates to a sequence of video frames (or video data) as provided by the streaming video server 130.

A video file comprise a sequence of video frames which are often in a compressed format (for example MPEG), wherein the compression consists of ‘in-frame’ compression and ‘between-frames’ compression. A data file of streaming video is a stream of data packets that comprise information on the video file but not necessarily on a frame-by-frame basis.

It will be appreciated that instead of streaming video, the present invention also relates to a downloadable video data file in which a video file is contained. In that case, the present invention relates to an embodiment in which the streaming video server 130 will be embodied as a file server capable of providing video files for downloading by the client computer 110.

The communication between client computer 110 and content server 120, and between client computer 110 and streaming video server 130 may be using any suitable communication protocol.

In one embodiment, the communication between client computer 110 and content server 120 is by means of TCP/IP (transmission control protocol/Internet protocol). The transmission of streaming video or the downloadable video file can be done by a network protocol which may be a part of the Internet protocol suite, which is known to persons skilled in the art.

For example, transmission of streaming video may be accomplished by means of the UDP protocol, but the present invention is not limited to this example,

The client computer 110 is further arranged to compose and display a media presentation which comprises a composed video image that relates to the received streaming video as well as the received content data.

Advantageously, the present invention achieves that the media presentation is no longer an invariable reproduction of a pre-recorded or captured video stream, but can be variable, adjustable, adaptable or even interactive, based on the received content data.

According to a further embodiment of the present invention, the client computer 110 is also arranged to compose and display a media presentation which comprises a composed video image that relates to the received streaming video as well as the received content data, in which the content data are variable in dependence on a client-related parameters, for example, in relation to the receiving client computer, some characteristics of the client computer, or adjustment signals generated by the client computer.

In a further example, the client related parameters may comprise a description of a user class, for example, a class of male adults between 16 and 30 interested in football.

A user of that class will be shown the streaming video together with content data as an overlay, while a user of another class may see the streaming video but not the overlay, or may see the streaming video with another overlay.

It is also conceivable that the client related parameters comprise data relating to a type of computer (or its capabilities) or some pre-sets/preferences of the computer.

The variability of the content related data will be explained in more detail below.

FIG. 2 shows a schematic diagram of a client computer according to the present invention.

Computer system 110 comprises host processor 21 with peripherals. The host processor 21 is connected to memory units 18, 19, 22, 23, 24 which store instructions and data, one or more reading units 30 (to read, e.g., floppy disks 17, CD ROM's 20, DVD's), a keyboard 26, a mouse 27 as input devices, and as output devices, a display 28 and a printer 29. Other input devices, like a trackball, a touch screen, a webcam, a microphone, a telephone handset or a scanner, may be provided as well as other output devices.

Further, a network I/O device 32 is provided for a connection to a network 200.

The memory units shown comprise RAM 22, (E)EPROM 23, ROM 24, tape unit 19, and hard disk 18. However, it should be understood that there may be provided more and/or other memory units known to persons skilled in the art. Moreover, one or more of them may be physically located remote from the processor 21, if required.

The processor 21 is shown as one box, however, it may comprise several processing units functioning in parallel or controlled by one main processor, that may be located remotely from one another, as is known to persons skilled in the art.

The host processor 21 comprises functionality either in hardware or software components to carry out their respective functions as described in more detail below. Skilled persons will appreciate that the functionality of the present invention may also be accomplished by a combination of hardware and software components. As known by persons skilled in the art, hardware components, either analogue or digital, may be present within the host processor 21 or may be present as separate circuits which are interfaced with the host processor 21. Further, it will be appreciated by persons skilled in the art that software components may be present in a memory region of the host processor 21.

The client computer system 110 shown in FIG. 2 is arranged for performing computations in accordance with the method of the present invention. The client computer 110 is capable of executing a computer program (or program code) which after being loaded in the computer system allows the computer system to carry out the method of the present invention.

It will be appreciated that the computer system as shown in FIG. 2 may also represent a content server 120 or a streaming video server 130, and may have the functionality required by either the content server 120 or the streaming video server 130.

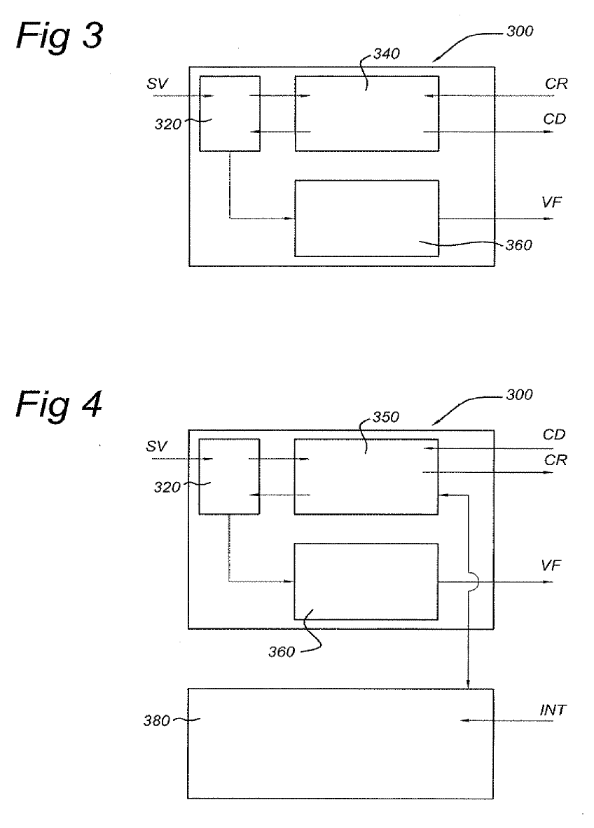

FIG. 3 shows a schematic diagram of a media presentation program according to the present invention.

The media presentation program 300 is depicted as a block diagram indicating functions of the program.

The media presentation program 300 is capable of displaying video streams on the display of the client computer 110.

The media presentation program 300 comprises a video frame controller 320, a video image composer 340 and a video image displayer 360.

The video frame controller 320 is connected to the video image composer 340. The video frame controller 320 is arranged for controlling the flow of video image frames within the media presentation program.

The video frame controller 320 controls the receipt of video data SV from the streaming video server 130. Also, the video frame controller 320 is arranged for controlling transmission of the video data SV to the video image composer 340 and receipt of individual composed video images from the video image composer 340.

The video image composer 340 is further arranged for controlling transmission of each composed video image (received from the video image composer 340) to the video image displayer 360.

The video image composer 340 is arranged for composing a composed video frame VF based on individual video data SV and content data CD from the content server 120.

To obtain content data CD from the content server 120, the video image composer 340 is capable of retrieving an identifier from the video data SV to be processed, and transmitting the identifier in a content request CR to the content server 120, after which the content data CD that relates to the identifier is received from the content server 120.

The content request CR may contain additional variable information for interaction with the content data CD, which additional variable information may be used to instruct the content server 120 to reply to the content request CR in a manner which depends on the information comprised in the content request CR.

The content request CR may contain a client computer-related parameter, for example, in relation to the receiving client computer, or some characteristics of the client computer, or interaction signals generated by the client computer.

In other words, depending on the content of the content request CR, the content data CD sent by content server 120 may vary.

As a consequence the composed video frame VP comprises a video frame and a variable element related to the content data CD. The variable element can in dependence on the content data be an adjustable element or an interactive element, i.e., the element can be adjusted or adapted interactively.

After completing a composed video frame VF, the video image composer signals completion of the composed video frame VF to the video frame controller 320. Also, this signaling may be used by the video frame controller 320 to obtain next video data SV as being received from the streaming video server 130.

The video frame controller 320 is connected to the video image displayer 360 so as to control transmission of the composed video frame VF to the video image displayer 360.

The video image displayer 360 is arranged for displaying the composed video frame VF on the display.

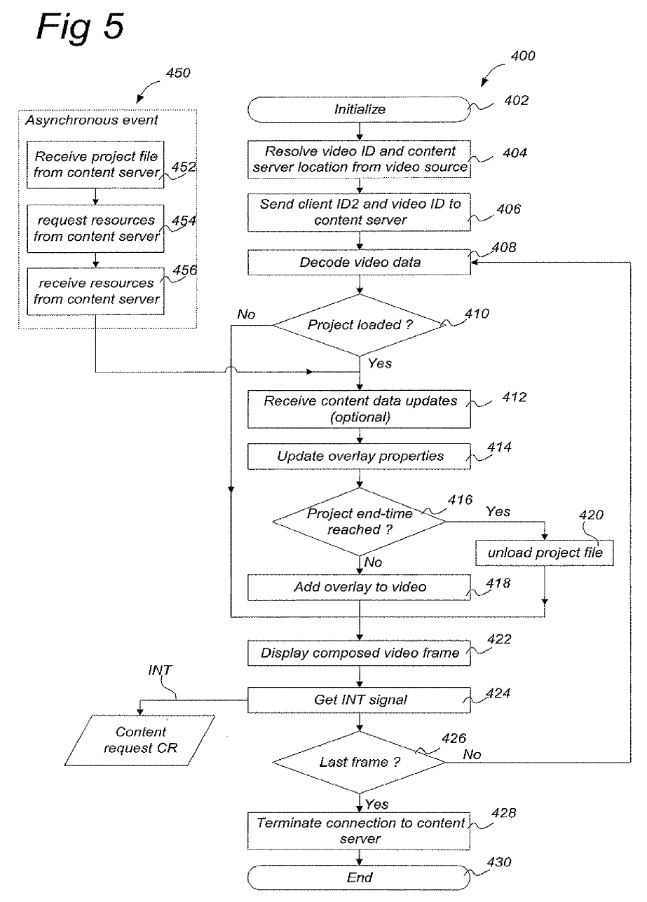

The function of the media presentation program 300 will be described in more detail with reference to FIG. 5.

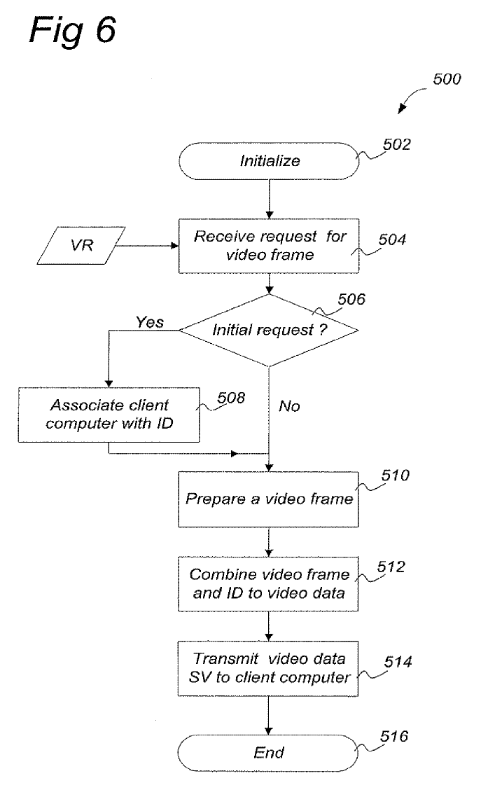

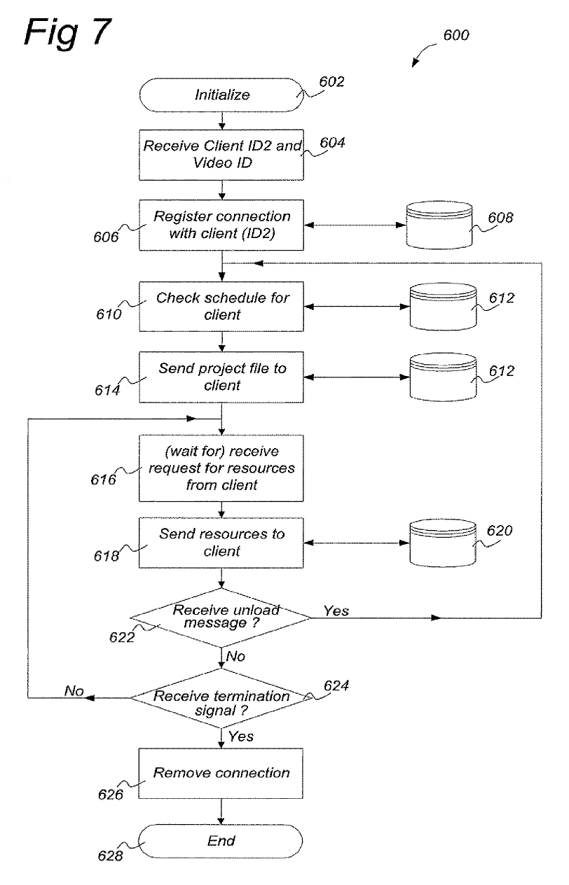

The function of the streaming video server 130 and the content server 120 will be described in more detail with reference to FIG. 6 and FIG. 7, respectively.

FIG. 4 shows a schematic diagram of a media presentation program according to a further embodiment of the present invention.

In the further embodiment shown in FIG. 4, the media presentation program 300 comprises a video frame controller 320, a further video image composer 350, video image displayer 360, and an interaction handler 380.

In FIG. 4 entities with the same reference number as shown in the preceding figures refer to the corresponding entities in the preceding figures.

The further video image composer 350 comprises the functionality as described above with reference to the video image composer 340. Additionally, the further video image composer 350 is connected to the interaction handler 380.

The further video image composer 350 is capable of determining the content of the content data CD in relation to the presence of adjustable elements within the content data CD.

Adjustable elements relate to items or objects within the content data CD such as text or a picture or a movie, on which an adjustment response or an adaptation response by the client computer 110, or by a user-generated input of the client computer, may be carried out.

If the further video image composer 350 detects an adjustable element in the content data CD, the adjustable element (or an associated signal of the adjustable element) is handed over to the interaction handler 380.

The interaction handler 380 is arranged for receiving the adjustable element (or its associated signal) and for signaling that an adjustment response by the client computer 110, may be carried out (i.e., an adjustment response may be made by the client computer directly, or by an interaction of the user of the client computer).

In case user input is used to carry out the adjustment, the signaling may be done by providing information within the composed video frame VF, for example by showing a dialog box, or a hyperlink element, and/or an audible signal. Below, this will be illustrated in more detail.

Subsequently, the interaction handler 380 may provide an adjustment signal INT generated by the client computer to the further video image composer 350 as a reply to the received adjustable element.

The adjustment signal INT may be generated by means of one or more of the input devices. Also, the adjustment signal INT may be generated by means of program code within the memory of the client computer 110 without user adjustment or interaction.

The further video image composer 350 then prepares the content request CR by including a reply to the adjustable element, which reply corresponds to the adjustment signal INT as generated.

FIG. 5 shows a flow diagram of a portion of the media presentation program to be carried out by the client computer 110.

The media presentation program comprises two procedures which are executed in a substantially concurrent manner. A video image composer program 400 runs concurrently with at least one other program 450 that is used for communication with the content server.

The video frame composer program 400 serves to compose the composed video frame VF.

The at least one other program 450 may be carried out as an asynchronous procedure substantially simultaneously with the video image composer program 400.

In the asynchronous procedure (event) 450, the processor of the client computer 110 communicates with the content server 120.

Tn action 452 of the asynchronous procedure 450, the processor of the client computer 110 receives a project file from the content server 120, in response to a procedure carried out in action 406 (sending an identifier ID of the video file and a second identifier ID2 of the client computer 110 to the content server 120), which will be described in more detail below.

The project file relates to a set of rules for the video image composer program which define in which manner a composed video frame VF is to be composed from the video data SV and the content data CD.

In a subsequent action 454, the processor carries out instructions to determine if resources are required form the content server and if so, which resources. The resources relate to the content data CD as described above. If resources are required, the processor of the client computer executes a procedure to request, by means of a content request CR, the required resources (the content data CD) from the content server 120.

In a further action 456, the processor receives requested resources (content data) from the content server 120.

The asynchronous procedure 450 ends at action 458.

Now referring again to procedure 400, in a first action 402, the processor of the client computer may carry out some initializations and/or preparative actions.

In this action a selection is made as to which video file (i.e., a video stream or a downloadable video file) is to be displayed on the display of the client computer.

Note that procedure 400 may be carried out on a video source that is either a downloaded video file or an incoming video stream.

After selection, the processor executes a procedure to download the selected video file from the video source.

In action 404, the processor executes a procedure to resolve an identifier ID that relates to the selected video file from the streaming video server 130.

Next in action 406, the processor executes a procedure to send the identifier ID of the video file and a second identifier ID2 which relates to the client computer 110 to the content server 120.

In a subsequent action 408, the processor carries out instructions to decode video data SV from the selected video file to form a regular video frame VA from such a video file. The decoding operation creates the regular video frame VA from video data SV obtained from the video source in a manner known from the prior art.

In action 410, next after action 408, the processor executes a test if required resources (content data CD) have been downloaded from the content server 120 (symbolically depicted by arrow 409), as illustrated above with reference to the first asynchronous procedure 450.

If the test indicates that no content data CD are available, the regular video frame VA will be handled without content data, transformed in a composed video frame without adjustable content and be displayed as such. In that case, the procedure 400 is continued in action 422, which will be described below.

Else, if the test indicates that content data CD has been downloaded in the asynchronous procedure 450, the procedure 400 continues in action 412.

In action 412, which is optional, the processor checks with the content server 120 if additional content data updates are available for the composed video frame VF to be formed. If so, the additional content data is retrieved from the content server 120.

This optional action 412 allows to provide ‘up-to-the-minute’ or ‘live’ content data CD (such as variable text) to be used in the formation of the composed video frame VF.

In case action 412 is carried out by the processor, a second optional action 414 will follow action 412. In action 414, the processor updates the content data CD, as received in the asynchronous procedure 450, with the updates obtained in action 412.

In next action 416, the processor tests if an end-time of the project file has been reached.

Such an end-time may be related to a given particular video frame within the video stream (e.g., a frame number or serial number) or also to time information of the client computer 110 (e.g. time on system clock).

Using such an end-time allows to use content data on a series of consecutive video frame VF, for example to show a commercial or preview before a main video presentation.

If in action 416, the processor determines that the end-time is not reached, the procedure continues in action 418, else the procedure continues in action 420.

In action 418, the processor composes the composed video frame VF from the regular video frame VA obtained in action 408 and the content data CD obtained from the asynchronous procedure 450, possibly updated in the optional actions 412 and 414.

The content data CD not only comprise displayable information but may also describe in which manner the composed video frame VF is to be formed. The content data CD are described below in more detail.

In case the end-time of the project file was reached in action 416, the processor carries out action 420. In action 420, the processor unloads the project file from memory. The processor transmits a completion message to the server that the loaded project file has been processed.

Further in this action 420, the processor may establish a new connection to the content server 120 and request a next project file which relates to upcoming video frames to be created. By this request a next asynchronous procedure 450 is initiated and a new project file may be available to the client computer at action 410.

The procedure continues in action 418 so as to form the composed video frame of the now unloaded project file.

Next, in action 422, the processor carries out instructions so as to have the composed video frame VF displayed on the display linked to the client computer 110.

In action 424, the processor tests if an input signal is available as an adjustment signal INT (for example, an input from the user of the client computer 110). If so, the adjustment signal INT is processed by the processor and included in a next content request for the content server 120.

It is noted that as known to the skilled person adjustment signals also may be generated on an interrupt basis, asynchronously from the procedure 400.

In action 426, the composed video frame VF comprises the last regular video frame VA from the video source. If so, the procedure continues in action 426, else the procedure continues in action 408.

In action 428, the processor carries out instructions to terminate the connection to the content server 120 and a termination signal is transmitted to the content server 120. Also in this action, the processor may terminate the connection to the streaming video server 130, if this connection to the video server 130 is still open.

In action 430, the procedure 400 ends.

The content data CD comprise data that relate to the content request CR. Some data of the content data CD may be variable as a function of the variable information data, such as the adjustment signal INT.

The content data CD may comprise any information required to define any conceivable adjustable element within the composed video frame VF. The content data CD may comprise processing data comprising information on the manner in which the video frame is to be processed (for example the processor is instructed to carry out an image processing action).

The content data CD may comprise composition data that relate to the appearance of the video image to be composed. In that case, the processor of the client computer 110 may be instructed by the composition data in which manner a composed video image frame is to be built.

The content data CD may also comprise a sequence of instructions (e.g., a machine-readable script) relating to a manner in which the video data are to be processed by the processor of the client computer.

For example, the processor may be instructed by the composition data to create an overlay of either a text frame or a picture frame or a movie frame which may also be a side bar, a floating box or the like within the composed video image frame.

Since the media presentation program composes the composed video frames VF on a frame-by-frame basis, the content data CD can be changed per frame if required. Moreover, the procedure 400 allows to maintain content data CD within the displayed video image for a sequence of more than one video frames. Also adjustment signals within content requests CR may be transmitted on a frame-by-frame basis to the content server 120.

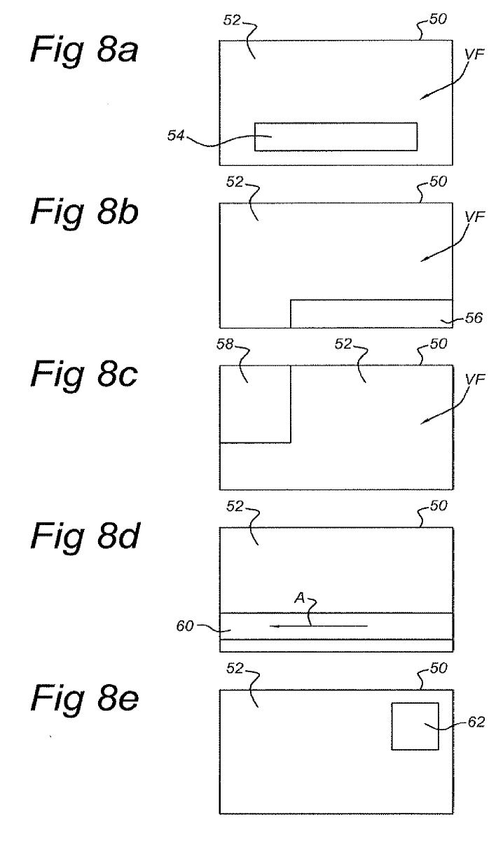

Examples of composed video image frames will be described below with reference to FIG. 8a-8e.

FIG. 6 shows a flow diagram 500 of a program to be carried out by a streaming video server.
The streaming video server 130 is capable of transmitting video data SV over the data communication network 200 to the client computer 110. The sequence of such video data is referred to as streaming video.

In a first action 502, the processor of the streaming video server 130 may carry out some initializations and/or preparative actions.

In action 504, the processor of the streaming video server 130 receives a video request VR from the client computer 110 to receive video data SV from a streaming video.

This video request VR may comprise an identification of the client computer 110 and/or an identification of the video data SV requested.

In action 506, the processor of the streaming video server checks if the video request VR is an initial request to open the video stream. If so, the program continues ill action 508, else the program continues in action 510.

In action 508, the processor associates the requesting client 110 with an identifier ID for the requested video stream.

In action 510, the processor of the streaming video server prepares a video frame from the requested video stream.

In action 512, the processor of the streaming video server combines the prepared video frame and the identifier ID into video data SM. This action may comprise encoding of the video data by the processor.

Next, in action 514, the processor executes instructions so as to transmit the video frame data SV to the requesting client computer 110.

In action 516, the procedure ends.

FIG. 7 shows a flow diagram of a program to be carried out by a content server.

In a first action 602, the processor of the content server 120 may carry out some initializations and/or preparative actions.

In a next action 604, the processor of the content server 120 receives a registration request from the client computer 110. The registration request comprises the identifier ID of the video file selected on the streaming video server 130 and the second identifier ID2 of the client computer 110.

Next, in action 606, the processor of the content server executes a procedure to register the connection with the client computer 110. The processor may check the received identifiers ID, ID2 with a database file 608, which comprises information on pre-registered client computers.

Next, in action 610, the processor checks if a project file is available for the registered client computer 110, based on the information from the received identifiers ID, ID2. The availability of a project file can be retrieved from a scheduling database 612 which comprises information on both the identifier ID of the selected video file and on the second identifier ID2 of the client computer 110.

Based on the identifiers ID, ID2 the processor can establish which project file is to be provided to the client computer 110. The processor selects the project file to be provided based on predetermined definitions.

In subsequent action 614, the processor transmits the selected project file to the registered client computer 110.

Then, in action 616, the processor checks for a content request CR from the client computer 110 (see FIG. 5, action 454). (As described above in relation to FIG. 5, the content request CR is associated with the video data SV received by the client computer 110 from the streaming video server 130.)

If the content request CR is made, then the procedure 600 continues in action 618, else the procedure 600 will continue in action 622.

When the request is made, in action 618 the processor carries out instructions to retrieve the requested resources (i.e. content data CD) from a content database 620, and to transmit the content data CD to the client computer 110.

Based on a value of one or both of the identifiers ID, ID2, the retrieving procedure may relate to different content data CD. For example, the content data CD may relate to a text box or picture box or movie box to be provided with the media presentation. Alternatively, the processor of the content server may compile content data CD based on a data processing scheme. For example, in case a text box with a communication session (a chat session) is provided with the media presentation, the content data CD may relate to quotes of the communication. Also, the content data CD may relate to a window within the media presentation that shows a scrolling text (such as a news ticker).

When no request has been made in action 616, in action 622 the processor checks if the client computer 110 has transmitted a completion message for the project file. If so, the procedure 600 will continue at action 610, else the procedure 600 will continue at a next action 624.

In action 624, the processor of the content server checks if the client computer has transmitted the termination signal (see FIG. 5, action 426). If so, the procedure continues in action 626, else the procedure returns to action 616.

In action 626, the processor carries out instructions to remove the registered connection for the client computer 110.

Subsequently, in action 628, the procedure ends.

It is noted that during procedure 600 the processor of the content server may carry instructions to keep record of communications and actions (i.e., the transmission of data) between the client computer and the content server for statistical purposes. Such statistical records may be stored in a database of the content server, and may be used for example to define a user profile for the client computer 110.

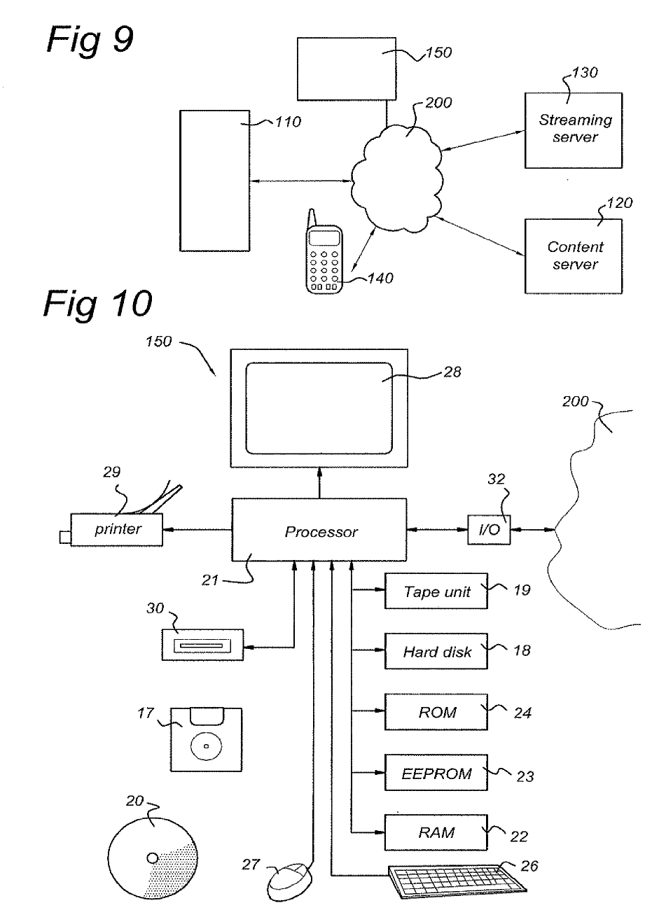

Alternatively or additionally, in action 618 the processor of the content server 120 is capable to present to the client computer 110 associated data originating from a further computation device which is an external electronic information source on the network 200. FIG. 9 shows a schematic diagram of a system according to an embodiment. In FIG. 9 entities with the same reference number as shown in the preceding figures refer to the corresponding entities in the preceding figures. The system as shown in FIG. 9 comprises the client computer 110, the content server 120, the streaming video server 130 and the farther computation device 150, which are interconnected by the network 200.

FIG. 10 shows a schematic diagram of the further computation device 150. In FIG. 10 entities with the same reference number as shown in the preceding figures refer to the corresponding entities in the preceding figures.

Such further computation device is arranged for providing information as associated data of the content data, which associated data through the content server 120 are usable as at least a portion of the content data. The associated data may relate to any type of content data as described above. Also, the associated data may relate to data provided by a third party. In one embodiment, typically, the content server 120 provides to the client computer 110 at least a portion of the content data comprising additional instruction data that enables the client computer 110 to fetch or obtain the associated data from the further computation device. Such additional instruction data relate to for example, a resource locator or an address tag, or a script or any other form of meta-data that the processor of the client computer 110 can use to obtain the associated data for the further computation device. In another embodiment, the content server 120 is capable to directly present to the client computer 110 associated data from the further computation device on the network 200. Upon receiving the content request CR from the client computer 110, the content server 120 is arranged to fetch or obtain the associated data from the further computation device by using the additional instruction data. Subsequently, the content server transmits the associated data as a portion of the content data to the client computer 110.

In a preferred embodiment, the additional instruction data allow either the content server or the client computer to instruct the further computation device to run a selection process for selecting associated data that are stored on the other computation device. The additional instruction data in this case may comprise some selection criterion for the further computation device to use in selecting the associated data requested by either the content server or the client computer. The selection criterion may be based on one or more of the identifiers ID, ID2, or may be based more generally on the client related parameters as described above.

FIGS. 8a, 8b, 8c, 8d, 8e show schematic examples of media presentation frames in accordance with the media presentation program of the present invention.

FIGS. 8a-8e shows a media frame 50 of the media presentation program 300 which media frame 50 may be a ‘window’ within the display. The media frame 50 defines the area of the display in which the media presentation program may display video images.

Here the media frame 50 is shown as a rectangular shape but other shapes of the media frame 50 are conceivable as well.

The media presentation program 300 is capable of displaying the composed video image VF within the media frame 50 on the display.

In FIG. 8a, the media frame 50 shows an example of a composed video image VF which comprises in a first area 52 of the media frame 50 a representation of the video image as received from the streaming video server 130, and in a second area 54 as adjustable element an interactive text box which displays text complied from the content data CD. In FIG. 8a, the second area 54 is an overlay on the first area 52.

In FIG. 8b, the media frame 50 shows an example of a composed video image VF which comprises in a first area 52 of the media frame 50 a representation of the video image as received from the streaming video server 130, and in a third area 56 as adjustable element a communication box in which a communication session is displayed. The information in the communication box is associated with the content data CD.

In this case interaction by a user from the keyboard may be handled by the interaction handler 380 so as to provide input to the communication session (through the content request CR to the content server 120).

In FIG. 8c, the media frame 50 shows an example of a composed video image VF which comprises in a first area 52 of the media frame 50 a representation of the video image as received from the streaming video server 130, and in a fourth area 58 as adjustable element a box comprising a browser-like page which is associated with the content data CD.

The user may interact with the content of the fourth area by providing an adjustment signal INT by means of interaction handler 380.

In FIG. 8d, the media frame 50 shows an example of a composed video image VF which comprises in a first area 52 of the media frame 50 a representation of the video image as received from the streaming video server 130, and in a fifth area 60 as adjustable element a scrolling information window (scrolling being indicated by arrow A).

For example, the scrolling information window displays data such as a news ticker, which data are derived from the content data CD.

In the example of FIG. 8d, the scrolling is shown in a horizontal direction, but it is noted that alternatively scrolling can be done in another direction such as the vertical direction.

In FIG. 8e, the media frame 50 shows an example of a composed video image VF which comprises in a first area 52 of the media frame 50 a representation of the video image as received from the streaming video server 130, and in a sixth area 62 as adjustable element a picture box or image box.

The sixth area 62 of the picture box or image box is shown as an overlay of the first area 52. The picture box or image box displays a picture or image that is associated with the content data CD. Also, the picture box or image box may display a second video image (i.e., a movie).

The user may have interaction with the information shown in the sixth area 62 through the interaction handler 380.

In the examples of FIG. 8a-8e, the second, third, fourth, fifth and sixth area 54, 56, 58, 60, 62 are shown with particular shapes and locations. It is noted that each of the areas 54-62 may be positioned and shaped differently if required. Also, each of the areas 54-62 may be a floating box that is movable over the first area 52.

Furthermore, it is noted that a composed video image VF may comprise the first area that represents the video image and any combination of the second, third, fourth, fifth and sixth areas 54, 56, 58, 60, 62.

It is noted that the content displayed in the second, third, fourth, fifth or sixth area 54, 56, 58, 60, 62 may relate to data associated with adverts or XML feeds

The skilled person will appreciate that the examples of FIGS. 8a-9e are not intended to limit the invention. Other types of interactivity within a media presentation may be conceivable within the scope of the present invention.

Furthermore, it is noted that the media presentation program 300 may be implemented as a stand-alone media player program. Alternatively, the functionality of the media presentation program may be implemented as an add-on or plug-in for a prior art media player program or a program for playing streaming video. The media presentation program 300 can also be embedded in a web browser application.

Also, the media presentation program 300 may be implemented in a media player device, smart phone, pda (personal digital assistant), set-top box or digital television set, provided such a device is capable of connecting to the content server and the media server.

Alternatively, the functionality of the media presentation program may be implemented as an add-on or plug-in for a prior art media player device, smart phone, pda, set-top box or digital television set.

Although, the description above refers to video images and video frames, it will be appreciated that such images and frames may comprise audio signals which may be played by the client computer in coherence with the video frames or images. The audio signals may be in any suitable format or coding.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A client computer, for viewing a media presentation, comprising a processor and memory, the processor being connected to the memory; the client computer being arranged for connecting to a network and for receiving video image data from a video server on the network;
the client computer further being arranged for:
making a content request to a content server the network, for receiving content data from the content server, the content request comprising content request data being associated with the received video image data, and the content data being associated with the video image data, and
composing a composed video image based on the video image data and the content data,
wherein the client computer is arranged for determining an identifier from the video image data, wherein the content request comprises the identifier, and wherein the client computer is arranged for providing in the content request additional variable information for interaction with the content data; the additional variable information comprising a client computer-related parameter, and wherein the client computer receives a project file from the content server, in response to sending the identifier of the video file and a second identifier of the client computer to the content server, the project file relating to a set of rules which define in which manner a composed video frame VF is to be composed from the video image data and the content data.

2. The client computer according to claim 1, wherein the client computer comprises a display, the processor being connected to the display, and the client computer is arranged for displaying the composed video image on the display.

3. The client computer according to claim 1, wherein the client computer is arranged for:
determining if the content data comprises an adjustable element, and if the adjustable element is present:
handling the adjustable element and
providing an adjustment response to the adjustable element in the content request.

4. The client computer according to claim 3, wherein handling the adjustable element comprises generating an adjustment signal;
the adjustment signal being generated by at least one of a group of:
an input device and a program code executed by the processor, and the adjustment response to the adjustable element being associated with the adjustment signal.

5. The client computer according to claim 1, wherein the composed video frame comprises in a first area a representation of the video data as received from the video server, and in at least one further area a representation that relates to the content data as received from the content server.

6. The client computer according to claim 1, wherein a portion of the content data comprises associated data originating from a further computation device.

7. The client computer according to claim 1, wherein a portion of the content data comprises additional instruction data, the additional instructional data enabling the processor of the client computer to carry out obtaining of associated data from a further computation device.

8. The client computer according to claim 7, wherein said obtaining of associated data comprises that the client computer instructs the further computation device to run a selection process for selecting associated data that are stored on the further computation device.

9. A video server comprising a processor and memory, the processor being connected to the memory; the video server being arranged for connecting to a network and being arranged for providing a video stream to a requesting client computer on the network; the video stream comprising a sequence of video frames;
the video server being arranged for combining a video frame from said sequence of video frames with an identifier for said client computer into video data, the video data being transmitted to the client computer, the processor being arranged to associate the requesting client computer with the identifier.

10. The video server according to claim 9, wherein the video server is further arranged for encoding the video data.

11. A content server comprising a processor and memory, the processor being connected to the memory; the content server being arranged for connecting to a network and being arranged for providing content data to a client computer, the client computer being arranged for composing the content data with video data from a video server, wherein the content server is arranged for preparing the content data in relation to a content request received from the client computer, wherein the content request comprises a first identifier that is associated with the video data from the video server,
and a second identifier that is associated with the client computer,
and the content server is arranged for preparing the content data in relation to the identifier,
and wherein in the content request additional variable information is provided for interaction with the content data; the additional variable information comprising a client computer-related parameter,
and wherein the content server checks if a project file is available for the client computer, based on the information from the received first and second identifiers, and based on the first and second identifiers establishes which project file is to be provided to the client computer, selecting the project file to be provided based on predetermined definitions
and transmits the selected project file to the client computer.

12. The content server according to claim 11, wherein the provided content data comprises an adjustable element.

13. The content server according to claim 12, wherein the content server compiles the content data in relationship with an adjustment response of the client computer to the adjustable element, the adjustment response being part of the content request.

14. The content server according to claim 11, wherein the content server is arranged to include in a portion of the content data associated data originating from a further computation device.

15. The client computer according to claim 14, wherein upon reception of the content request, the content server is arranged to instruct the further computation device to run a selection process for selecting the associated data that are stored on the further computation device, and
to obtain the selected associated data from the further computation device.

16. The content server according to claim 11, wherein a portion of the content data comprises additional instruction data, the additional instructional data enabling the client computer to obtain associated data from a further computation device.

17. A method for viewing a media presentation, comprising:
receiving video image data from a video server on a network;
making a content request to a content server on the network, for receiving content data from the content server, the content request comprising content request data being associated with the received video image data, and the content data being associated with the video image data, determining an identifier from the video image data, the content request comprising the identifier, and
providing in the content request additional variable information for interaction with the content data; the additional variable information comprising a client computer-related parameter,
receiving a project file from the content server, in response to sending the identifier of the video image data and a second identifier of the client computer to the content server, the project file relating to a set of rules which define in which manner a composed video frame is to be composed from the video image data and the content data, and
composing a composed video image based on the video image data and the content data.

18. The method according to claim 17, further comprising:
determining if the content data comprises an adjustable element, and if the adjustable element is present:
handling the adjustable element and
providing an adjustment response to the adjustable element in the content request.

19. The method according to claim 18,
wherein handling the adjustable element comprises generating an adjustment signal;
the adjustment signal being generated by at least one of a group of:
an input device and a program code executed by the processor, and the adjustment response to the adjustable element being associated with the adjustment signal.

20. A computer program, for viewing a media presentation, to be loaded by a client computer, the client computer comprising a processing unit and memory; the processing unit being connected to the memory; the client computer being arranged for connecting to a network, wherein
the computer program after being loaded allows the processing unit to carry out:
receiving video image data from a video server on the network;
making a content request to a content server on the network, for receiving content data from the content server, the content request comprising content request data being associated with the received video image data, and the content data being associated with the video image data, determining an identifier from the video image data, the content request comprising the identifier, and
providing in the content request additional variable information for interaction with the content data; the additional variable information comprising a client computer-related parameter,
receiving a project file from the content server, in response to sending the identifier of the video image data and a second identifier of the client computer to the content server, the project file relating to a set of rules which define in which manner a composed video frame is to be composed from the video image data and the content data, and
composing a composed video image based on the video image data and the content data.

21. The computer program according to claim 20, wherein the computer program is a either a media player program or a program for playing streaming video.

22. The computer program according to claim 21, wherein the computer program is an add-on or plug-in for either a media player program or a program for playing streaming video or a web-browser application.

23. A data carrier for the computer program as claimed in claim 20.

24. A device comprising one selected from a group of a media player, a smart phone, a personal digital assistant, a set-top box, and a digital television set, wherein the device comprises the client computer according to claim 1.

25. A device comprising one selected from a group of a media player, a smart phone, a personal digital assistant, a set-top box, and a digital television set, wherein the device is arranged with capabilities in accordance with the method of claim 17.

26. A data carrier for a computer program as claimed in claim 21.

27. A data carrier for a computer program as claimed in claim 22.
